(19) United States
(12) Patent Application Publication
(10) Pub. No.: US 2012/0218773 A1
(43) Pub. Date: Aug. 30, 2012

(54) SEMICONDUCTOR LUMINAIRE

(75) Inventors: Kimberly Peiler, Northville, MI (US); Christopher L. Eichelberger, Livonia, MI (US)

(73) Assignee: OSRAM OPTO SEMICONDUCTORS GMBH, Regensburg (DE)

(21) Appl. No.: 13/395,667

(22) PCT Filed: Sep. 25, 2009
(86) PCT No.: PCT/US09/58309

§ 371 Date: May 15, 2012

(51) Int. Cl. B60Q 1/04; F21V 5/04; F21V 29/00; F21V 5/00

(52) U.S. Cl. 362/520; 362/311.14; 362/311.06; 362/294; 362/235; 362/240

(57) ABSTRACT

A semiconductor luminaire includes a carrier; an optoelectronic semiconductor chip mounted on the carrier, the semiconductor chip emitting ultraviolet or visible radiation; a luminaire housing not covering the semiconductor chip in a direction of main emittance; an optical cover placed downstream of the semiconductor chip in a direction of mails emittance: and an index matching layer located between the semiconductor chip mid the optical cover, wherein the optical cover provides a radiation exit surface of the luminaire, and wherein radiation running along the direction of main emittance from the semiconductor chip to the radiation exit surface solely propagates in solid or liquid materials.

### RELATED APPLICATIONS

This is a §371 of International Application No. PCT/US2009/058309, with an inter-national filing date of Sep. 25, 2009 (WO 2011/037571 A1, published Mar. 31, 2011), the subject matter of which is incorporated by reference.

### TECHNICAL FIELD

This disclosure relates to semiconductor luminaires, particularly to semiconductor luminaires which have a high light out-coupling efficiency.

### SUMMARY

Provided are semiconductor luminaires including a carrier; an optoelectronic semiconductor chip mounted on the carrier, the semiconductor chip emitting ultraviolet or visible radiation; a luminaire housing not covering the semiconductor chip in a direction of main emittance; an optical cover placed downstream of the semiconductor chip in a direction of main emittance; and an index matching layer located between the semiconductor chip and the optical cover, wherein the optical cover provides a radiation exit surface of the luminaire, and wherein radiation running along the direction of main emittance from the semiconductor chip to the radiation exit surface solely propagates in solid or liquid materials.

Also provided are vehicular headlamps including the semiconductor luminaires.

### BRIEF DESCRIPTION OF THE DRAWINGS

Advantageous examples and developments of the semiconductor luminaire and the vehicular headlamp will become apparent from the representative examples described below in association with the figures.

FIG. 1A is a schematic sectional view of a semiconductor luminaire.

FIG. 1B is an exploded schematic sectional view of a portion of the semiconductor luminaire of FIG. 1A.

FIG. 2 is a schematic sectional view of another luminaire with one semiconductor chip.

FIG. 3 is a schematic sectional view of another luminaire with two semiconductor chips.

FIG. 4 is a schematic sectional view of yet another semiconductor luminaire.

FIG. 5 is a schematic sectional view of a portion of another semiconductor luminaire.

FIG. 6A is a schematic sectional view of yet another semiconductor luminaire.

FIG. 6B is a top view of the semiconductor luminaire of FIG. 6A.

FIG. 7A is a schematic sectional view of a portion of a semiconductor luminaire comprising a plurality of optoelectronic semiconductor chips.

FIG. 7B is a top view of the semiconductor luminaire of FIG. 7A.

FIG. 7C is another top view of the semiconductor luminaire of FIG. 7A.

FIG. 8A is a schematic sectional view of a semiconductor luminaire with a plurality of semiconductor chips.

FIG. 8B is a top view of the semiconductor luminaire of FIG. 8A.

FIG. 9A is a schematic sectional view of a gasket and optical cover in connection with a semiconductor luminaire.

FIG. 9B is a schematic sectional view of a multilayered structure that may be used in accordance with the structure of FIG. 9A.

FIG. 10 is a schematic sectional view of still another semiconductor luminaire.

FIG. 11 is a schematic sectional view of still a further semiconductor luminaire.

### DETAILED DESCRIPTION

The semiconductor luminaire may comprise a carrier. The carrier provides mechanical stability for the semiconductor luminaire. The carrier can also serve as an electrical connection means. By way of example, the carrier can be a printed circuit board, a circuit board, a metal core board, or a ceramic board with conductor paths. Preferably, the carrier has a low thermal resistance. For example, an average thermal conductivity of the carrier is equal to or exceeds 40 W/(m K), especially 100 W/(m K).

The semiconductor luminaire may comprise at least one optoelectronic semiconductor chip. The semiconductor chip may be mounted on the carrier and is capable of emitting ultraviolet or visible radiation during operation of the luminaire. For example, the semiconductor chip is a thin film chip with a thickness of at most 200 μm, especially of at most 20 μm with regard to epitaxially grown layers. The semiconductor chip can be formed as described in WO 2005/081319 A1 or DE 10 2007 004 304 A1, of which the disclosed content relating to the semiconductor chip is hereby incorporated by reference. Especially, the semiconductor chip can be a light-emitting diode or a laser diode or a super-luminescent diode.

The semiconductor luminaire may further comprise a luminaire housing. The housing does not in this instance cover the semiconductor chip in a direction of main emittance. Particularly, if the semiconductor chip shows a Lambertian radiation characteristic, the direction of main emittance is essentially perpendicular to a main surface of the semiconductor chip. In this case, in a direction perpendicular to the main surface of the semiconductor chip, there is no part of the luminaire housing. The luminaire housing is preferably made from a material or comprises such a material that is not transparent or translucent to the electromagnetic radiation generated by the semiconductor chip. For example, the luminaire housing comprises a sheet metal.

The semiconductor luminaire may comprise an optical cover. In the direction of the main emittance of the semiconductor chip, the optical cover may be placed downstream of the semiconductor chip. In other words, a main part of the radiation generated by the optoelectronic semiconductor chip runs to and preferably through the optical cover. The optical cover can comprise or consist of a glass, a plastic or the like. Suitable plastic materials are, for example, polycarbonate, polymethylmetacrylate, a liquid crystal polymer, an epoxy or an epoxy-silicon-hybrid material. Preferably, the optical cover is fashioned to be transparent and/or see-through for the radiation generated by the semiconductor chip or at least for a part of this radiation.

An index matching layer may be located between the semiconductor chip and the optical cover. The index matching material consists of a liquid or, preferably, of a solid. Also preferably, the index matching layer may be made from a material being see-through with regard to the radiation or at least with regard to a part of the radiation generated by the semiconductor chip in service of the luminaire.

The index matching layer may be in direct contact with the optical cover. In other words, the material of the index matching layer touches a material of the optical cover.

The index matching layer may have an optical refractive index between 1.4 and 1.9, especially between 1.55 and 1.8, inclusive. Especially, the optical refractive index of the material of the index matching layer is between the refractive index of the semiconductor chip and of the optical cover.

The optical cover may provide a radiation exit surface of the semiconductor luminaire. In other words, a surface of the semiconductor luminaire by which the radiation generated by the semiconductor chip leaves the luminaire is comprised by the optical cover. Thus, the radiation exit surface of the optical cover also is an outer surface of the whole semiconductor luminaire.

The radiation running along the direction of main emittance from the semiconductor chip to the radiation exit surface may solely propagate in solid or liquid materials. Preferably, all radiation emitted at the radiation exit surface of the optical cover solely runs in solid materials from the semiconductor chip to the radiation exit surface. In other words, there is especially no air gap in-between the semiconductor chip and the radiation exit surface, at least in the direction of main emittance. Because of that, the radiation emitted by the semiconductor chip does not have to run through boundary surfaces that are defined by a rapid, step-like jump in the optical refractive index. Because of that, the radiation out-coupling efficiency is increased.

The semiconductor luminaire may comprise a carrier and an optoelectronic semiconductor chip mounted on the carrier. In service of the semiconductor luminaire, the semiconductor chip is suited to emit an ultraviolet and/or a visible radiation. The semiconductor luminaire may further comprise a luminaire housing, the luminaire housing not covering the semiconductor chip in a direction of main emittance. Moreover, the semiconductor luminaire may comprise an optical cover that is placed downstream of the semiconductor chip seen in the direction of main emittance. Furthermore, the semiconductor luminaire may include an index matching layer that is located between the semiconductor chip and the optical cover. Thereby, the optical cover provides a radiation exit surface of the luminaire. Also, the radiation running along the direction of main emittance from the semiconductor chip to the radiation exit surface solely propagates in solid and/or liquid materials.

The optical cover may be shaped lens-like, at least in places. Hence, by means of the optical cover, a radiation profile of the radiation emitted by the semiconductor luminaire can be formed in a pre-defined manner. For example, the optical cover collimates the radiation generated by the semiconductor chip.

The semiconductor luminaire may further comprise a heat sink. The heat sink can be a passive one or an active one. For example, the heat sink comprises cooling fins. It is also possible that the heat sink comprises a thermal-electrical element, for instance a Peltier element, or a fan. Also, a cooling effect by the circulation of a gas or a liquid could be realized by the heat sink.

The carrier may be a printed circuit board that is directly provided on the heat sink. That the carrier is directly provided on the heat sink can mean that there is only an adhesive like a solder in between the carrier and the heat sink. Because of that, a low thermal resistance in between the carrier and the heat sink can be realized. Hence, an efficient cooling of the optoelectronic semiconductor chip can be performed through the heat sink.

The optical cover may comprise a flange. The flange is, for instance, a pedestal-like structure that in a lateral direction at least partially surrounds the lens-like part of the optical cover.

The optical cover may be fixed to the semiconductor luminaire by means of the luminaire housing and by means of the flange. In other words, the flange can be pressed, for example, to the carrier by a distinct part of the luminaire housing.

A gasket that is comprised by the semiconductor luminaire may be located between the optical cover and the luminaire housing to seal the carrier and the semiconductor chip, especially against dust, humidity and water. Preferably, the gasket is in direct contact both with the optical cover and the luminaire housing. The gasket can comprise or consist of, for instance, a rubber and/or a silicon.

The gasket, the luminaire housing and the optical cover may overlap in a lateral direction. In other words, there may be a straight line oriented in parallel with the direction of main emittance that crosses that gasket as well as the luminaire housing and as the optical cover.

The semiconductor chip may be mounted directly onto the carrier. In other words, in between the semiconductor chip and the carrier, there is at most an adhesive like a solder or an electrically conductive glue. Preferably, there are no other parts between the semiconductor chip and the carrier, especially no materials like plastics that have a low thermal conductivity.

The semiconductor luminaire may further comprise a chip housing, wherein the semiconductor chip is placed in the chip housing. The housing can comprise a lead frame and a plastics material as well as a casting material.

The chip housing may be mounted directly onto the carrier in such a way that, preferably, there is only an adhesive in between the chip housing or parts of the chip housing and the carrier. An adhesive in this sense is also a heat-conductive paste that is arranged in between parts of the chip housing and the carrier. Especially, the chip housing comprises a thermal socket on which the semiconductor chip is mounted, the socket being thermally contacted to the carrier by the heat-conductive paste.

The semiconductor luminaire may comprise a plurality of semiconductor chips wherein all semiconductor chips are covered by the optical cover. Especially, in directions perpendicular to the main surfaces of the semiconductor chips, the semiconductor chips are followed by the optical cover. Thus, a main part of the radiation generated by the semiconductor chips travels through the optical cover.

The optical cover may be one-pieced. In this case, it is possible that the semiconductor luminaire comprises exactly one optical cover.

The optical cover may comprise a lens array. The lens array is especially integrally formed with the optical cover. Thus, the optical cover and lens array are formed in one piece.

Each lens of the lens array of the optical cover and each semiconductor chip may be assigned in a one-to-one manner with respect to each other. Thus, the number of semiconductor chips may also be equal to the number of lenses of the lens array.

The semiconductor luminaire may comprise a plurality of semiconductor chips and a plurality of optical covers, wherein the optical covers are disposed on the carrier and displaced in a lateral direction. Preferably, each optical cover is assigned to one or more semiconductor chips. In this case, the semiconductor luminaire comprises more optoelectronic semiconductor chips than optical covers.

The radiation exit surface of the optical cover may be flush with an outer surface of the luminaire housing. This enables an especially flat design of the semiconductor luminaire.

The semiconductor chip may be located in a recess of the optical cover. Especially, the semiconductor chip may be completely surrounded by the optical cover and the carrier and eventually also by an adhesive that locks the optical cover and the carrier to each other.

Furthermore, a vehicular headlamp is provided. The headlamp is especially suited for use in a motor vehicle such as cars or trucks. Especially, the vehicular headlamp comprises one or more luminaires according to one of the preceding forms. Thus, the subject matter disclosed for the semiconductor luminaire is also disclosed for the vehicular headlamp and vice-versa.

In the representative examples and figures, similar or similarly acting constituent parts are provided with the same reference symbols. The elements illustrated in the figures and their size relationships among one another should not be regarded as true to scale. Rather, individual elements may be represented with an exaggerated size for the sake of better representability and/or for the sake of better understanding.

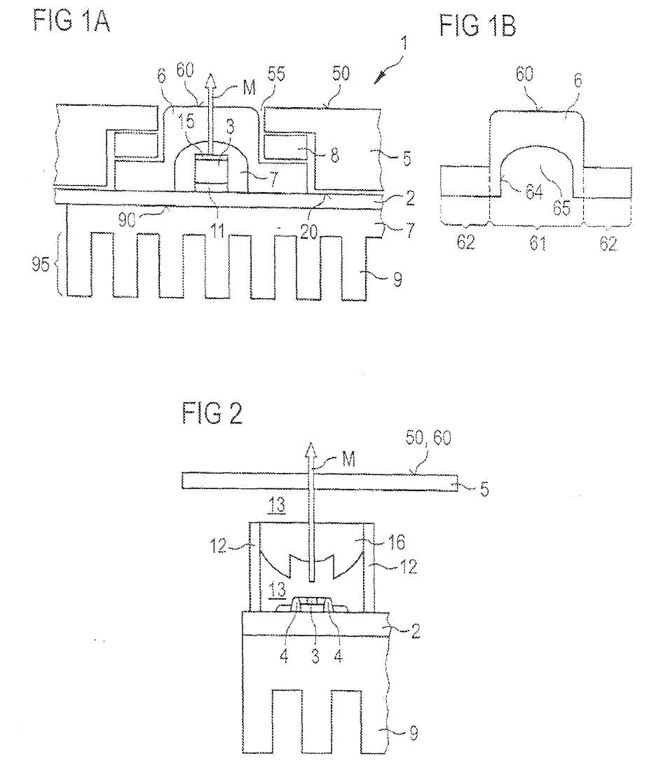

In FIG. 1A, an exemplary form of a semiconductor luminaire 1 is shown in a sectional view. The semiconductor luminaire 1 that can be a vehicular headlamp comprises an optical cover 6, shown in more detail in the sectional view in FIG. 1B. The semiconductor luminaire 1 further comprises a heat sink 9 with a top face 90 and with cooling fins 95 remote from the top face 90. A carrier 2 is arranged on the top face 90. As an example, the carrier 2 is a printed circuit board, a metal core board or a ceramic, equipped with conductive paths on a main area 20 of the carrier 2, the main area 20 being remote from the heat sink 9.

By means of an adhesive 11, an optoelectronic semiconductor chip 3 is mounted on the main area 20 of the carrier 2. The adhesive 11 is, for instance, a solder. In service of the semiconductor luminaire 1, the semiconductor chip 3 is suited to emit visible and/or ultraviolet radiation in a direction M of main emittance, indicated by an arrow. As an example, the direction M of main emittance is oriented essentially perpendicular with respect to the main area 20 of the carrier 2. The main area 20 could be made reflective for the radiation. In a variant, not shown in the figures, the direction of main emittance is deflected by, for instance, an additional mirror that follows the semiconductor chip.

Further, the semiconductor chip 3 is surrounded on surfaces that do not face the carrier 2 with an index matching layer 7. The semiconductor chip 3 is completely surrounded by the index matching layer 7 and the carrier 2. The index matching layer 7 is roughly shaped in the form of a hemisphere.

A luminescence conversion material 15 in the form of a layer is attached on a surface of the semiconductor chip 3 remote from the carrier 2. The luminescence conversion material 15 absorbs at least part of the radiation emitted by the semiconductor chip 3 and converts this radiation to a radiation with another wavelength. Thus, the radiation emitted by the semiconductor luminaire 1 can be white light that comprises radiation originally emitted by the semiconductor chip 3 mixed with radiation generated by conversion in the conversion luminescence material 15. The conversion luminescence material 15 can be present in all figures, although not drawn explicitly.

Moreover, the optical cover 6 comprises a lens part 61 and flanges 62. In the lens part 61, the optical cover 6 is shaped lens-like. Via the lens part 61, a radiation characteristic of the radiation emitted by the semiconductor chip 3 and by the luminescence conversion material 15 can be formed. Further, the optical cover 6 comprises a recess 65 in which the semiconductor chip 3 and the index matching layer 7 are arranged. An inner surface 64 of the recess 65 is in direct contact with the index matching layer 7.

Via the flanges 62 that can partially or completely surround the lens part 61 in a lateral direction, the optical cover 6 is fixed to the carrier 2 and the heat sink 9 by a gasket 8 and a luminaire housing 5. In a direction parallel to the direction M of main emittance, the flanges 62 of the optical cover 6, the gasket 8 and a part of the luminaire housing 5 are stacked one above the other. Hence, the optical cover 6 is pressed through the gasket and the luminaire housing onto the carrier 2. By means of the gasket 8, the semiconductor chip 3, as well as the carrier 2, are sealed against dust, water and/or humidity. Thus, the gasket 8 is in direct contact both with the luminaire housing 5 and the flanges 62 of the optical cover 6.

A radiation exit surface 16 of the semiconductor luminaire 1 is formed by the optical cover 6. Thus, the radiation from the semiconductor chip 3 only runs in solid materials from the semiconductor chip 3 to the radiation exit surface 60. Hence, the radiation exit surface 60 of the optical cover 6 is also an outer surface of the semiconductor luminaire 1.

The luminaire housing 5 has an outer surface 50. The luminaire housing 5 further comprises an opening 55 in which at least the lens part 61 of the optical cover 6 is arranged. Especially, the outer surface 50 of the luminaire housing is flush with the radiation exit surface 60 of the optical cover 6.

In FIG. 2, an example of another luminaire with one semiconductor chip 3 is illustrated. The chip 3 is located in a chip housing 4. Thus, the chip 3 is not in direct contact with the carrier 2. Furthermore, there is an air gap 13 in between the chip 3 and a lens 16. The lens 16 is fixed to the carrier 2 by two holders 12. A further air gap 13 is present between the lens 16 and the luminaire housing 5 that is transparent to the radiation emitted by the semiconductor chip 3. The housing 5 forms an outer surface 50 of the luminaire as well as a radiation exit surface 50. Also, the chip 3 is covered by the housing 5 in a direction parallel to the direction M of main emittance of the radiation generated by the chip.

Due to the air gaps 13, there is a relatively large discontinuity with regard to the optical refractive index in between the chip 3 and the air gap, in between the two air gaps 13 and the lens 16 as well as in between the air gap 13 remote from the carrier 2 and the housing 5. On each boundary surface of these air gaps, due to the jump in the optical refractive index, about 5% of the radiation is reflected back to the carrier 2 and/or the chip 3. Thus, due to the two air gaps 13, a light-out-coupling efficiency of the luminaire according to FIG. 2 is reduced by roughly 10%. This loss of about 10% is not present in the selected structures such as, for example, in the semiconductor luminaire 1 as depicted in FIG. 1. Thus, the efficiency of the semiconductor luminaire 1 according to FIG. 1, for instance, is increased.

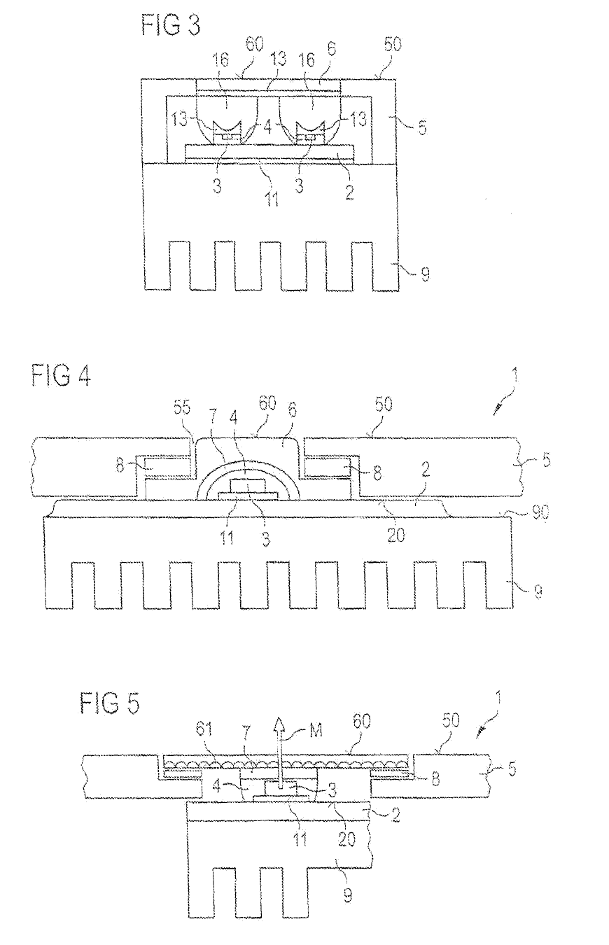

In FIG. 3, another luminaire with two semiconductor chips 3 is illustrated. According to FIG. 3, there is also an air gap 13 between an optical cover 6 and a lens 16. Due to this air gap, a light out-coupling efficiency of the device according to FIG. 3 is reduced by about 5% compared with the semiconductor luminaire 1 as depicted in FIG. 1. There may also be an air gap between the lenses 16 and the semiconductor chips 3 that could further reduce the efficiency of the luminaire.

Furthermore, there is a comparably large thermal resistance due to the housing, the carrier 2 and the adhesive 11 in between the semiconductor chip 3 and the heat sink 9. Thus, a performance with regard to thermal aspects of the luminaire according to FIG. 3 is decreased. As the semiconductor chip 3 according to FIG. 1 is mounted directly on the carrier and the carrier 2 is in direct contact with the heat sink 90, heat transfer from the semiconductor chip 3 to the heat sink 9 is increased.

FIG. 4 shows another example of a semiconductor luminaire 1. In contrast to the structure of FIG. 1, the semiconductor chip 3 is arranged in the chip housing 4, for example, made from a silicone, a silicone-epoxy-hybrid material, an epoxy or the like. The chip housing 4 is shaped lens-like and can serve to decrease an angle of emittance of the radiation generated by the semiconductor chip 3.

The semiconductor luminaire 1 can be used in a vehicular headlamp as well as all other examples such as in FIGS. 5 to 11. In this case, a radiation characteristic of the radiation emitted by the semiconductor luminaire 1 preferably is asymmetric to fulfill the requirements of a headlamp, for example, for a car.

In the examples as depicted in FIG. 5, the optical cover 6 comprises a plurality of lens parts 61, each formed as a microlens. The lens parts 61 of the optical cover 6 can be formed similarly. Alternatively, it is also possible that the lens parts 61 differ from each other to form, for instance, a Fresnel lens-like optical cover 6.

The semiconductor chip 3 is, as well as in FIG. 4, arranged in the chip housing 4. Via the chip housing 4, the radiation emitted by the semiconductor chip 3 is collected and led into the direction M of main emittance with a high efficiency. Due to the forming of a plurality of lens parts 61 in the optical cover 6, the semiconductor luminaire 1 can be formed to be very flat and volume-saving.

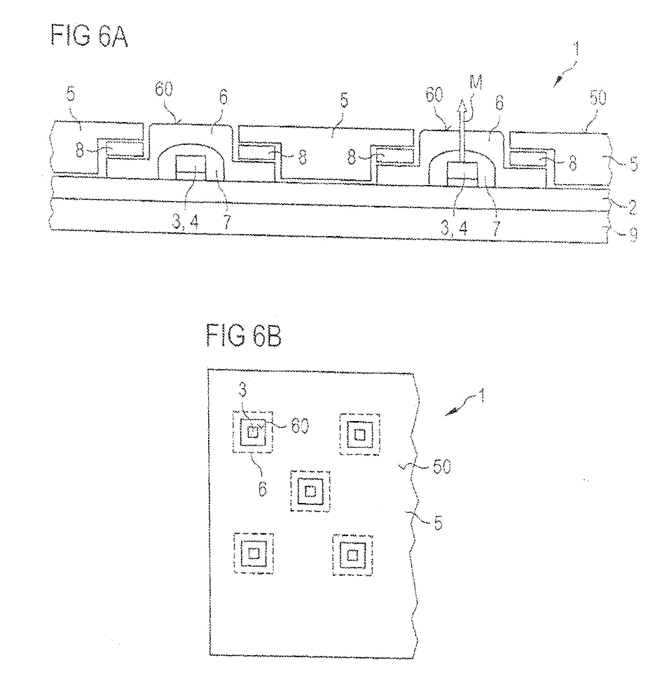

Now, referring to the example according to FIG. 6, such as in the sectional view of FIG. 6A and the top view in FIG. 6B, the semiconductor luminaire comprises a plurality of semiconductor chips 3 and also a plurality of optical covers 6. Each semiconductor chip 3 is assigned to exactly one of the optical covers 6 and vice-versa. Each of the optical covers 6 is fixed to the carrier 2 by means of the gaskets 8 and the one-pieced luminaire housing 5. Thus, a semiconductor luminaire 1 with a high luminosity can be achieved.

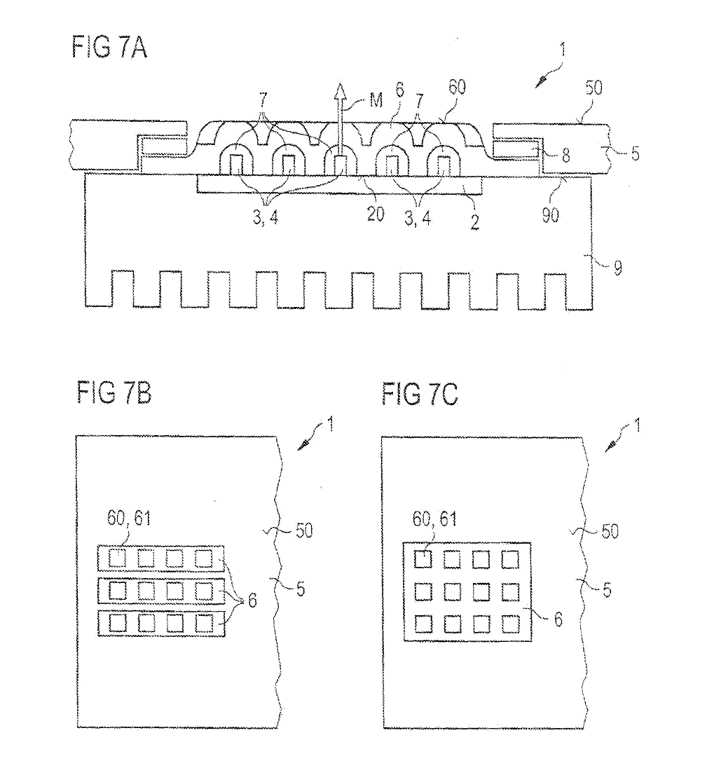

According to FIG. 7, such as in the sectional view in FIG. 7A and top views in FIGS. 7B and 7C, the semiconductor luminaire 1 comprises a plurality of optoelectronic semiconductor chips 3 and the optical cover 6 comprises a lens array with a plurality of lens parts 61. Each lens part 61 is assigned to one of the semiconductor chips 3. The carrier 2 is located in a recess of the heat sink 9. Thus, the main area 20 of the carrier 2 is flush with the top face 90 of the heat sink 9.

As shown in FIG. 7C, the optical cover 6 is one piece comprising the plurality of lens parts. As an alternative, the semiconductor luminaire 1 according to FIG. 7B comprises more optical covers 6, each of these optical covers 6 comprising, for example, four lens parts 61. Thus, in both cases the lens parts 61 are arranged in an array-like structure.

In contrast to the examples according to FIGS. 1 and 4 to 6, according to FIG. 7, the optical cover 6 projects over the carrier 2 in a lateral direction. Thus, in a direction parallel to the direction M of main emittance, the heat sink 9, the optical cover 6, the gasket 8 and the luminaire housing 5 are in subsequent direct contact with each other. By lateral projection of the optical cover 6 over the carrier 2, by fixing the optical cover 6 with the heat sink 9, the carrier 2 is mechanically disburdened.

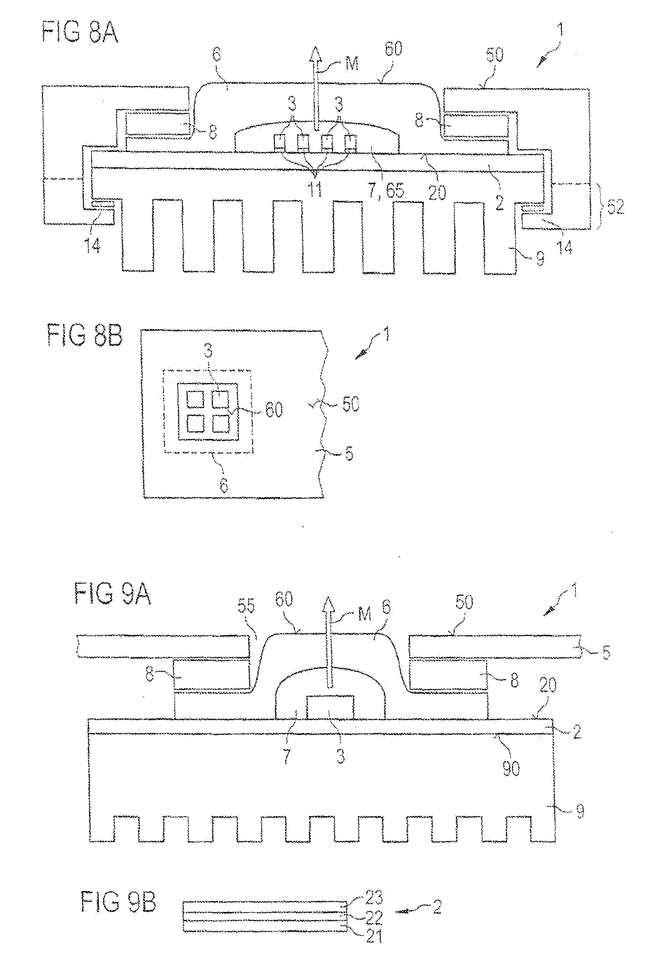

According to FIG. 8, the sectional view in FIG. 8A and the top view in FIG. 8B, the plurality of semiconductor chips 3 is arranged in one common recess 65 of the optical cover 6. The luminaire housing 5 is shaped U-like to clasp the optical cover 6 and the carrier 2 with the heat sink 9. Between a holding part 52 of the luminaire housing 5 and the heat sink 9, an additional sealing member 14 can be optionally provided to fully seal the semiconductor chips 3 and the carrier 2 from the environment/ambient conditions.

For the sake of simplifying the graphical representation, in FIG. 8B an arrangement of two times two semiconductors chips 3 is shown, deviating from the illustration of FIG. 8A.

According to the sectional view in FIG. 9A, the gasket 8 is flush with the optical cover 6 in a lateral direction perpendicular to the direction M of the main emittance of the semiconductor chip 3.

According to the sectional view in FIG. 9B, the carrier 2 can be a multi-layered structure comprising a dielectric layer 21, an electrically conductive layer 22 and a mask layer 23. The dielectric layer 21, for example, consists of or comprises a ceramic or a plastic. Preferably, the thermal resistance of the dielectric layer 21 is negligible. The electrically conductive layer 22 is, for instance, a copper layer. The mask layer 23 can be a layer of a structured solder. For example, the mask layer 23 is only present in regions where electrical contacts of the semiconductor chip 3 are applied to the carrier 2. An overall thickness of the carrier 2 can be between 100 μm and 2 mm, inclusive, preferably between 300 μm and 1 mm, inclusive.

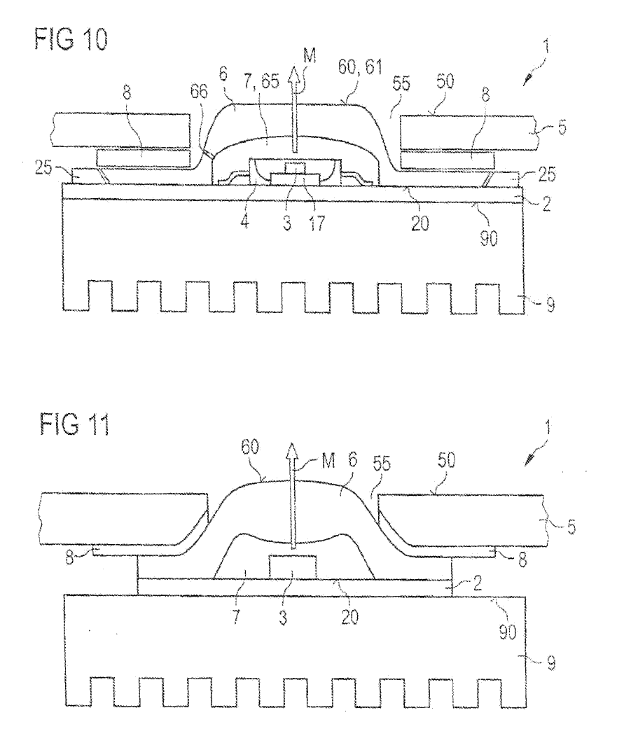

The carrier 2 according to the examples as shown in FIG. 10 comprises adjustor or adjustment means 25. Via the adjustment means 25, which have inclined lateral faces facing the optical cover 6, the optical cover 6 that also can have inclined lateral faces can be adjusted in a simple way and accurately with respect to the carrier 2.

The semiconductor chip 3 is, for example, arranged in a housing 4. Especially, the semiconductor chip 3 can be arranged on a socket 17 made of a thermally highly conductive material that is in thermal contact with the carrier 2, for instance by means of a thermal conductive paste.

It is possible that the chip housing 4 is soldered to the carrier 2 before the optical cover 6 is mounted. Either for filling the recess 65 with the material for the index matching layer 7 or to enable a release of air that otherwise would be trapped in the recess 65, the optical cover 6 optionally could comprise a duct 66 on a lateral surface of the lens-like part 61. Such a duct can also be provided in the optical covers of all examples.

Diverging from FIG. 10, the duct 66 could also be covered by the gasket 8 for better sealing of the duct 66. As in all other examples, the optical cover 6 can protrude from the outer surface 50 of the luminaire housing 5.

Another example is illustrated in FIG. 11. In this form, the carrier 2 is flush with the optical cover 6 to simplify mounting of the semiconductor luminaire 1. Lateral surfaces of the opening 55 in the luminaire housing 5 are tapered. Furthermore, the gasket 8 is fixed to a side of the luminaire housing 5 facing the heat sink 9. Thus, during the mounting of the semiconductor luminaire 1, the gasket 8 and the luminaire housing 5 can be regarded as being one piece. Due to the tapered lateral surfaces of the opening 55, a space in between the luminaire housing 5 and the optical cover 6 in a lateral direction near the outer surface 50 and the radiation exit surface 60, respectively, can be minimized. In this form, the gasket 8 projects in a lateral direction over the optical cover 6 and the carrier 2.

This disclosure is not restricted to the representative examples by the description on the basis of those examples. Rather, the disclosure encompasses any new feature and also any combination of features, which in particular comprises any combination of features in the claims and any combination of features in the examples, even if this feature or this combination itself is not explicitly specified in the claims or examples.

1. A semiconductor luminaire comprising:
a carrier;
an optoelectronic semiconductor chip mounted on the carrier, the semiconductor chip emitting ultraviolet or visible radiation;
a luminaire housing not covering the semiconductor chip in a direction of main emittance;
an optical cover placed downstream of the semiconductor chip in a direction of main emittance; and
an index matching layer located between the semiconductor chip and the optical cover,
wherein the optical cover provides a radiation exit surface of the luminaire, and
wherein radiation running along the direction of main emittance from the semiconductor chip to the radiation exit surface solely propagates in solid or liquid materials,

2. The semiconductor luminaire according to claim 1, wherein the optical cover is shaped lens-like at least in parts.

3. The semiconductor luminaire according to claim 1, further comprising a heat sink wherein the carrier is directly provided on the heat sink.

4. The semiconductor luminaire according to claim 1, wherein the optical cover comprises a flange, the optical cover being fixed to the carrier by the luminaire housing and by the flange.

5. The semiconductor luminaire according to claim 1, further comprising a gasket, the gasket located between the optical cover and the luminaire housing to seal the carrier and the semiconductor chip against ambient conditions.

6. The semiconductor luminaire according to claim 5, wherein the gasket, the luminaire housing and the optical cover overlap in a lateral direction.

7. The semiconductor luminaire according to claim 1, wherein the semiconductor chip is directly mounted onto the carrier, the carrier being one item selected from the group consisting of a circuit board, a printed circuit board, a ceramic and a metal core substrate.

8. The semiconductor luminaire according to claim 1, further comprising a chip housing which the semiconductor chip is placed in, the chip housing being directly mounted onto the carrier.

9. The semiconductor luminaire according: to claim 1, comprising a plurality of semiconductor chips, all semiconductor chips being covered by the optical cover, and the optical cover being one-pieced.

10. The semiconductor luminaire according to claim 1, wherein the optical cover comprises a lens array, each lens and each semiconductor chip being assigned one-to-one to each other.

11. The semiconductor luminaire according to claim 1, comprising a plurality of semiconductor chips and a plurality of optical covers, the optical covers being disposed on the carrier and displaced in a lateral direction and fixed by means of the luminaire housing, each optical cover being assigned to one or more semiconductor chips.

12. The semiconductor luminaire according to claim 1, wherein the radiation exit surface of the optical cover is flush with an outer surface of the luminaire housing.

13. The semiconductor luminaire according to claim 1, wherein the semiconductor chip is located in a recess of the optical cover.

14. A vehicular headlamp comprising the semiconductor luminaire according to claim 1.
